(19) United States
(12) Patent Application Publication
(10) Pub. No.: US 2004/0202805 A1
(43) Pub. Date: Oct. 14, 2004

(54) Inflatable hardening rope

(76) Inventor: David Chroman, Dunedin, FL (US)

Correspondence Address: LERNER AND GREENBERG, PA, P O BOX 2480, HOLLYWOOD, FL, 33022-2480, US

(21) Appl. No.: 10/412,823

(22) Filed: Apr. 14, 2003

(51) Int. Cl. B32B 1/02

(52) U.S. Cl. 428/34.1; 428/100

(57) ABSTRACT

An inflatable line includes strands, at least one being an inflatable bladder adapted to receive a fluid or a gas for making the line firm and less flexible. The strands form a rope of natural or synthetic fibers and the bladder is of a natural material, a synthetic material, rubber, nylon, plastic, or KEVLAR®. A line system is also provided and includes the line and a pump fluidically connected to the bladder. The pump can be a hand pump having a bulb, a connecting tube fluidically connected to the bladder, and a valve fluidically connecting the bulb to the connecting tube for controlling inflation and deflation of the bladder. The connecting tube can be removably connected to the bladder and/or to the valve. The bulb can transmit air or fluid. The pump can be a compressed air pump with a compressed air container, for example, a CO₂ cartridge.

### BACKGROUND OF THE INVENTION

1. Field of the Invention

The present invention relates, in general, to ropes and lines, and, in particular, to the hardening of those lines and providing the ability of reaching with such lines for the purpose of handling, placing, or utilizing them while allowing for the natural properties of the lines to be optimized.

2. Description of the Related Art

For centuries, ropes and lines have been utilized to take advantage of their primary features, tensile strength, and flexibility. Tensile strength is the measurement of a rope or line to be longitudinally stressed without tearing apart. Flexibility of a rope provides for easy storage and utilization based on the rope lacking rigidity. It is this lack of rigidity, or lack of flexibility, which provides for the greatest disadvantage to ropes or lines—to wit, a need to be in very close physical proximity with the secure area in order to attach the rope for its use.

With regard to application of prior art lines for boating, it is necessary to be close to or actually on the dock, in order to secure a boat line to the dock. In emergency rescue activities, it is also a requirement to be in physical proximity with the individual needing help in order to allow them to have access to the rescue line. In climbing activities, it is a need for the user to be at a point at which the rope is to be attached because a rope cannot be used to reach to a next higher level.

Currently, an alternative to physical proximity is the use of an external reaching device, i.e., a boat hook or a stick, in order to pass the line across a distance or to attach it to a secure location.

While some prior art devices modify the properties of lines, none have approached the issue of adding firmness for the purpose of easing handling.

For example, U.S. Pat. No. 2,162,130 to Somerville and U.S. Pat. No. 6,474,057 to Bertini et al. pertain to wire ropes and the need for lubrication of the wire ropes. These references discuss different processes for introducing lubrication to wire ropes.

U.S. Pat. No. 3,526,086 to Morgan discloses a multi-conduit underwater line, used as either flow lines or risers. Morgan discusses the desirability of flexibility for ease in laying the lines or for sustaining wide lateral displacements, thus restricting failure in such a line due to bending stresses.

In U.S. Pat. No. 3,853,149 to Stine, a composite tube, offering high temperature and low-density characteristics, aids in the tube's use as a fluid sampling device. The individual tubes do not allow for heat transfer between imbedded tubes.

U.S. Pat. No. 5,725,949 to Pasquali et al. discloses an improved method of mass transfer and/or heat exchangers by providing a greater level of protection against differing temperatures of the imbedded tubes.

Finally, U.S. Pat. No. 5,694,755 to Froystad discloses a buoyant material that is imbedded in a rope or line during the manufacturing process.

### SUMMARY OF THE INVENTION

The invention provides an inflatable hardening rope that overcomes the hereinafore-mentioned disadvantages of the heretofore-known devices of this general type and that solves the shortcomings inherent in the properties of lines, by introducing into the lines, during the manufacturing process, a bladder or hollow strand or balloon, that can be inflated with air or fluid, for the purpose of making the line less flexible and firm enough to support its own weight. Accordingly, an individual can control the line and direct it, from a reasonable distance, onto the secure location, for example, a boat dock cleat. The bladder or hollow strand can be inflated with a hand pump or bulb having an in-line valve to control the inflation and deflation processes. The line can have a loop, hook, or other configuration permanently or removably attached at the end depending on the particular application.

With the foregoing and other objects in view, there is provided, in accordance with the invention, an inflatable line including strands, at least one of the strands being an inflatable bladder. The bladder is adapted to receive a fluid or a gas for making the line firm and less flexible. The strands form a rope of natural or synthetic fibers and the bladder is of a natural material, a synthetic material, rubber, nylon, plastic, or KEVLAR®. A line system is also provided and includes the line and a pump fluidically connected to the bladder. The pump can be a hand pump having a bulb, a connecting tube fluidically connected to the bladder, and a valve fluidically connecting the bulb to the connecting tube for controlling inflation and deflation of the bladder. The connecting tube can be removably connected to the bladder and/or to the valve. The bulb can transmit air or fluid. The pump can be a compressed air pump with a compressed air container, for example, a CO₂ cartridge.

Other features that are considered as characteristic for the invention are set forth in the appended claims.

Although the invention is illustrated and described herein as embodied in an inflatable hardening rope, it is, nevertheless, not intended to be limited to the details shown because various modifications and structural changes may be made therein without departing from the spirit of the invention and within the scope and range of equivalents of the claims.

### DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1A is a plan view of an exemplary embodiment of an inflatable hardening line according to the invention with a loop at an end;

FIG. 1B is a plan view of another exemplary embodiment of the line of FIG. 1A with a hook at the end;

FIG. 2 is a fragmentary, plan view of an enlarged portion of the line of FIG. 1A with an inflation/deflation device and with the line being a braided rope;

FIG. 3A is a cross-sectional view of the line of FIG. 2 along section line III-III with a deflated bladder in a core thereof;

FIG. 3B is a cross-sectional view of the line of FIG. 2 along section line III-III with an inflated bladder in the core thereof;

FIG. 4 is a partially plan and partially enlarged, fragmentary, cross-sectional view of a further exemplary embodiment of the line of FIG. 1A with a three strand rope;

FIG. 5 is a cross-sectional view of the line of FIG. 4 along section line V-V with an inflated bladder in a center strand of one strand bunch;

FIG. 6 is a partially perspective and partially fragmentary plan view of yet another exemplary embodiment of the line of FIG. 1A with compressed air inflation; and

FIG. 7 is a plan view of another exemplary embodiment of the line of FIG. 1A with the loop formed as a lasso.

### DESCRIPTION OF THE PREFERRED EMBODIMENTS

While the specification concludes with claims defining the features of the invention that are regarded as novel, it is believed that the invention will be better understood from a consideration of the following description in conjunction with the drawing figures, in which like reference numerals are carried forward.

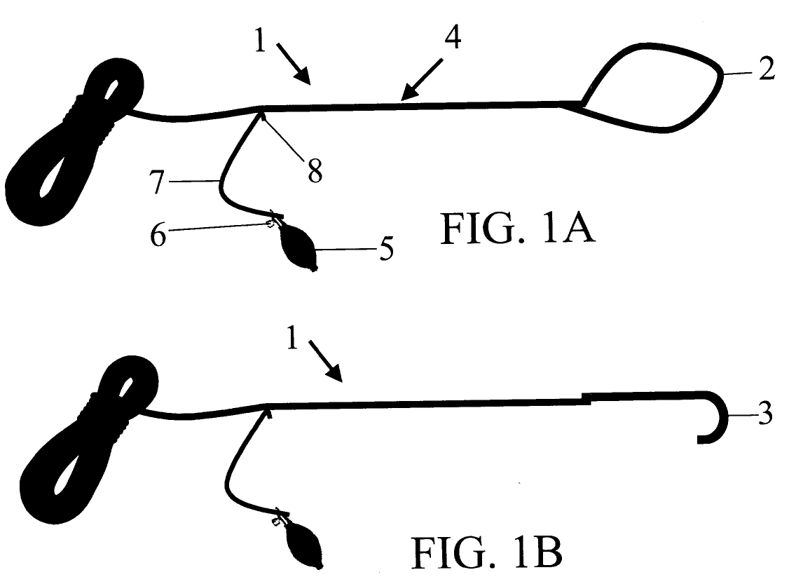

Referring now to the figures of the drawings in detail and first, particularly to FIG. 1A thereof, there is shown an overall drawing of a preferred embodiment of the invention as a rope or line 1, manufactured of natural or synthetic fibers. Preferably, the line 1 has a permanent loop 2, for example, spliced into the line. Alternatively, as shown in FIG. 1B, the line 1 can have a hook 3, for example, similarly spliced therein. The loop 2 or the hook 3 can be removably connected to the line 1. To extend the line beyond a handler's reach, the present invention includes a hollow strand or bladder 4 (see FIGS. 3A and 3B for greater detail) installed within a core 10 of the line 1, preferably, during a manufacturing process. Such an installation process is also referred to as being spun or laid.

To make the line 1 firm enough to support its own weight or even more than its own weight, the bladder 4 is inflated. The inflation process requires pumping a bellows, bulb, or pump 5 having an air release valve 6 that is set in a closed position. Preferably, the pump is a bulb and valve assembly similar in construction or identical to a bulb and valve of a sphygmomanometer. As the pump 5 is actuated, air enters a connecting tube 7, continues through an attaching device 8, which, preferably, is a quick connection union, and, then, enters into the bladder 4 within the line 1. As the air pressure increases and air fills the bladder 4, which is only has an opening at the attaching device 8, the bladder 4 increases tension along the sides of the line 1 and is restricted from expanding beyond the size of the core 10 (see FIGS. 3A and 3B). This tension results in a hardening and increased firmness of the line 1 sufficient to allow the line 1 to extend out horizontally (against gravity) from a user's hand that is grasping a location near the attaching device 8, for example. In such a position, the user will be able to extend the line 1 in any direction towards a desired location. For example, if a portion of the line 1 having the bladder 4 is four feet long, then a user grasping an area of the attaching device 8 after inflating the bladder 4 will be able to span a four foot chasm between a user and a non-illustrated hook on a vertical pole, for example, with the line and, thereby, attach the loop 2 onto the hook.

When the user determines that the line 1 no longer requires firmness, the user releases the air from the bladder 4 by setting the air release valve 6 to an open position, thereby, deflating the bladder 4 and returning the line I to its original flexibility.

The bladder 4 may be of a material that has the properties of flexibility and stretchability and, therefore, give the line 1 the ability to expand during the inflation process. The bladder 4 may be of natural or synthetic materials including rubber, nylon, plastic, KEVLAR®, or other suitable materials. The bladder 4 is sealed and is protected and restricted from over-expansion by the line materials surrounding it, i.e., fibers of a braided rope (compare FIGS. 3A and 3B).

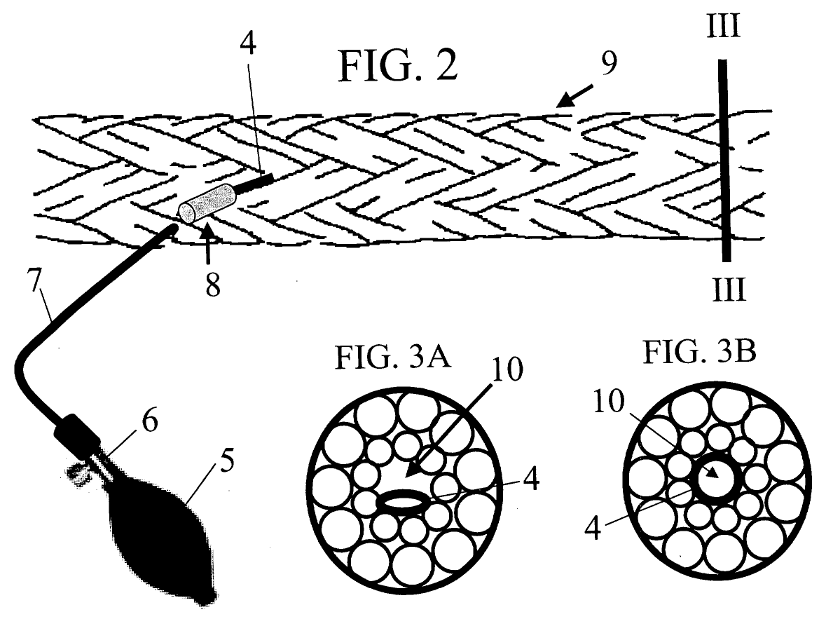

FIG. 2 shows a conventional braided rope or line 9, made of natural or synthetic materials, with the bladder 4 installed therein and extending through the braid and terminating in a female side of a quick connect union 8. The male side of the union, in this exemplary embodiment, is at a distal end of the connecting tube 7, the proximal end being connected to the air release valve 6.

FIG. 3A is a cross-sectional view of the braided line 9 with the bladder 4, installed in the central core 10, in a deflated condition. When pumped and filled with air, as shown in FIG. 3B, the bladder 4 expands to fill the entire core 10 and makes the bladder 4 and the line 1 firm.

FIG. 2 also illustrates a first embodiment of a pump 5 to be used for the inflation process. The pump 5 is operated using only one hand both to close the valve 2 and to pump the air into the connecting tube 3 by squeezing the bulb 5.

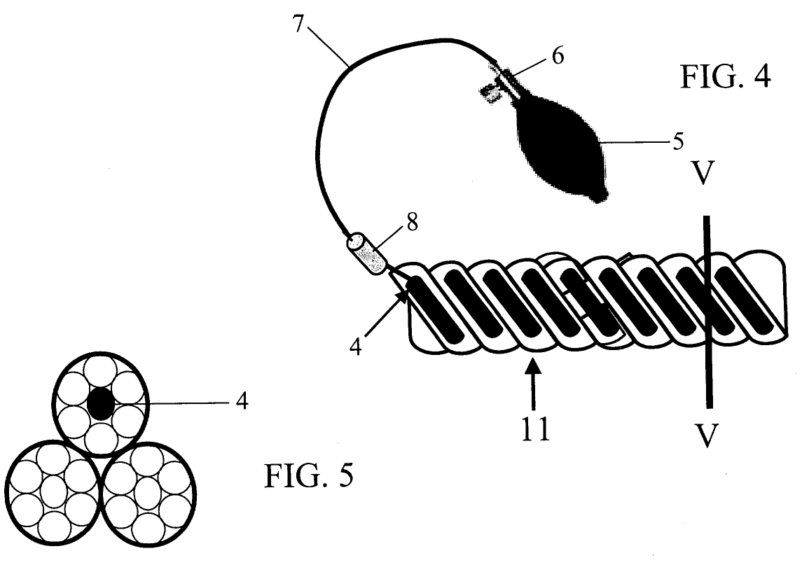

FIG. 4 is a cross-sectional view of the bladder 4 installed in a stranded rope or line 11. Also depicted are the pump 5, the air release valve 6, the connecting tube 7, and the quick-connect union 8.

A cross section of the stranded line 11 with the bladder 4 installed in one of the three strands is illustrated in FIG. 5. Preferably, installation is performed at the manufacturer. If additional firmness is required, then, additional bladders can be installed similarly in the other two strands and can be connected to the pump at a single quick-connect union 8 or at multiple unions. Many variations of the stranded line 11 embodiment are feasible.

The ends 2, 3 illustrated in FIGS. 1A and 1B also can include, for example, different permanently affixed or removable ends 2, 3 tailored to specific uses. Some examples include hooks, loops, magnet configurations, sharp or pointed objects for spearing objects, and baskets.

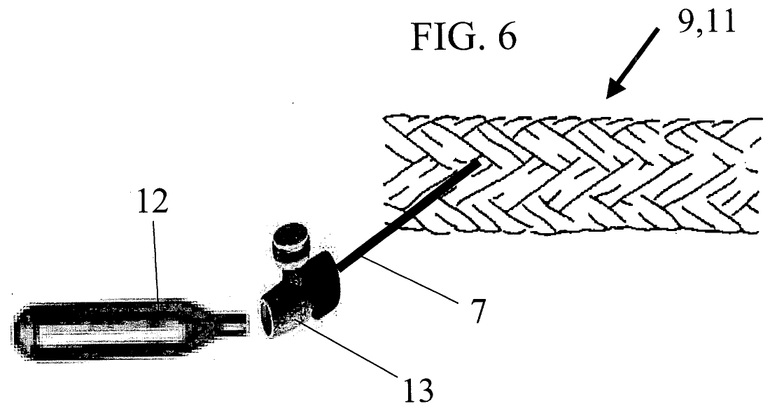

Other variations exist with respect to the methods of inflation. For example, as illustrated in FIG. 6, a single use compressed air cartridge 12 can provide instant inflation to the line 9, 11 through a corresponding inflation/deflation valve 13. Such a fitting can be an alternative or additional inflation device to the manual pump 5 of FIGS. 1A, 1B, 2, and 4. The instant inflation variant can employ a standard CO₂ cartridge 12 available at bicycling, motorcycling, ammunition, or sporting goods stores in a variety of sizes including 8, 12, 16, 25, and 45 gram capacities, the weight-determining factor being the quantity of air required for the size or the firmness of the line.

Also the connection between the cartridge 12 and the valve 13 can be threaded or non-threaded.

Use of a CO₂ cartridge allows for instant full inflation of a line and permits greater extension than a manual pump. Hand pumps that have built-in CO₂ capability, referred to as hybrid pumps, including, for example, the Genuine Innovations Slim Jim CO₂, also available at bicycle stores, can be used for increased flexibility and ease of use.

Compressed air is not the only way for filling the bladder 4. Instead, the bladder can be filled with a fluid. Fluid inflation permits greater rigidity and can be used for larger, heavier lines or applications. In such a case, the hand pump 5 can be used as a reservoir for the fluid when not used for inflation.

The line 1 according to the present invention has innumerable uses. The following paragraphs illustrate only a few.

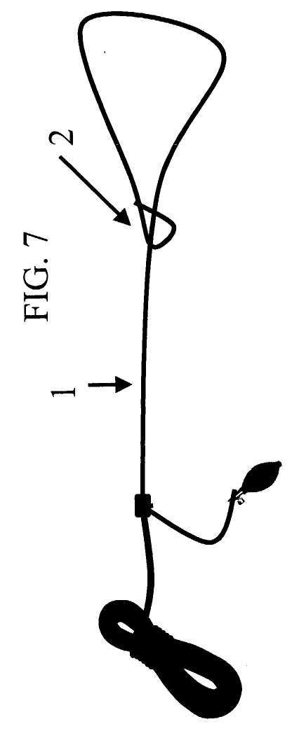

In a boat docking and mooring situation, the line 1 according to the present invention allows the user to reach for the dock and secure the boat without physically touching the dock. By extending an inflated boat line 1, the user can place the loop 2 or hook 3 around a docking cleat and draw the boat in using the natural tensile strength of the line 1. In a mooring situation, another boat line floating on the water can be grasped with an inflated line 1 having a hook 3 thereon, and, again, using the tensile strength of the line 1, the boat can be pulled towards the mooring for the purpose of securing the boat. The conventional procedure for placement of a line around a dock post or piling includes a user positioning him/herself sufficiently close to the piling for that individual to throw a loop successfully around the piling. A line 1 having a loop 2 thereon can be easily made into a lasso merely by pulling the line back through the loop 2 at the end of the line 1. Such a configuration is shown in FIG. 7. The ridges already existing in the line 1 will be sufficient to hold the loop 2 in place until the line is pulled upon, thus, tightening the loop and securing the boat.

In a rescue/emergency intervention situation, the line 1 of the present invention allows the rescue personnel to put the rescue line in a particular location, for example, in an injured individual's hand, in lieu of having that person catch or seek the end of the line 1. In a water rescue, the line 1 can safely be delivered to the individual in the water, while the rescuer maintains a safe distance, thus reducing or even eliminating the potential of a hysterical person injuring themselves and the rescuer. The line 1 of the present invention can be easily stored in car, home, boat, or recreational vehicle, and, in an emergency situation, be inflated manually or with the compressed air cartridge to produce an instant distress signal flag or signaling pole to aid in their recovery.

With regard to handicapped individuals, the line 1 of the present invention allows an individual to extend their reach, from any position. The embodiment shown in FIG. 1B is particularly advantageous. The line 1 can be stored in a small pouch, attached to a wheelchair, carried in a purse, or left on the bedside, and can be inflated with one hand, to allow the individual to reach and pull items towards him/her that, otherwise, would be inaccessible. Example uses include telephone handsets, salt and pepper shakers at an opposite side of a table, etc. Also, the inflatable line 1 can be used to pull a door towards a person restricted to a wheelchair, thus reducing a potentially dangerous and difficult operation.

In a ranching/animal handling situation, the line 1 of the present invention allows the individual to utilize a firm lasso, as described herein, for capturing and restraining animals, without the need to learn how to lasso or to be in close physical proximity to the animal.

With regard to rock climbing, mountain climbing, rappelling, etc., the line 1 of the present invention allows the individual to extend their reach, again, manually or with compressed air, to ease an ascent or descent, by reaching for a secure point remotely or for reaching other lines. The line 1 can be used in rescue and emergency climbing situations as well.

For farming/fruit picking, the line 1 of the present invention allows the individual to carry a “picking pole” conveniently in a folded pouch in their pocket or attached to a belt. By inflating the line with a permanently installed hook on the end, for example, a grower can reach up in a tree to sample the fruit from different heights or levels on a tree, without requiring a ladder or a pole for such a task.

For roof construction, the line 1 of the present invention allows the individual to lift tools, materials, or products from the ground to the roof, for example, without the need of a second individual to attach the line to the bundle to be moved. Using a hook 3 permanently affixed to the end of the line 1, for example, the individual can guide that line 1 from the roof and attach it to a paint can's handle, etc., from the roof.

With regard to electrical construction, the line 1 of the present invention allows an individual to “fish” a wall for wires, without the use of metal snake or other bulky apparatus. A line 1 that fits in the toolbox can be inflated and inserted into a wall and, then, directed to the location from which or to which the wire will be pulled. Less inflation in the line will allow for the line 1 to bend around corners or other obstacles, just as a wire can bend.

Similarly, for mechanical construction, the line 1 of the present invention allows the user to reach dropped screws or other metallic parts by inflating a line 1 with a permanently installed or removable magnet on the end. Such a line 1 can be inflated less fully to allow for bending and twisting when following the path towards the fallen object.

The foregoing description of the preferred embodiment of the invention had been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

I claim:

1. A line, comprising:
a plurality of strands, at least one of said strands being a bladder.

2. The line according to claim 1, wherein at least two of said strands are at least two bladders.

3. The line according to claim 1, wherein the bladder is an inflatable bladder adapted to receive a fluid or a gas for making the line firm and less flexible.

4. The line according to claim 1, wherein said strands define a core and said bladder is disposed in said core.

5. The line according to claim 4, wherein said core restricts said bladder and prevents said bladder from expanding outside said core.

6. The line according to claim 1, wherein said strands form a rope of natural or synthetic fibers.

7. The line according to claim 1, wherein:
said strands are connected to an end; and
said end is a loop, a hook, a magnet, a spear, or a basket.

8. The line according to claim 7, wherein said end is permanently connected to said strands.

9. The line according to claim 7, wherein said end is removably connected to said strands.

10. The line according to claim 1, wherein said bladder has only one entry/exit opening.

11. The line according to claim 1, wherein said bladder is of a natural material, a synthetic material, rubber, nylon, plastic, or KEVLAR®.

12. The line according to claim 1, wherein the line is a boat line, a rescue line, an animal leash, a lasso, a rappelling line, a fruit-picking line, an electrical wiring snake, or a plumbing snake.

13. A line system, comprising:
a line having a plurality of strands, at least one of said strands being a bladder; and
a pump fluidically connected to said bladder.

14. The line according to claim 13, wherein:
at least two of said strands are at least two bladders; and
said pump is fluidically connected to said at least two bladders.

15. The line system according to claim 13, wherein said strands define a core and said bladder is disposed in said core.

16. The line system according to claim 15, wherein said core restricts said bladder and prevents said bladder from expanding outside said core.

17. The line system according to claim 13, wherein said bladder has only one entry/exit opening.

18. The line system according to claim 13, wherein said bladder is of a natural material, a synthetic material, rubber, nylon, plastic, or KEVLAR®.

19. The line system according to claim 13, wherein said strands form a rope of natural or synthetic fibers.

20. The line system according to claim 13, wherein:
said strands are connected to an end; and
said end is a loop, a hook, a magnet, a spear, or a basket.

21. The line system according to claim 20, wherein said end is permanently connected to said strands.

22. The line system according to claim 20, wherein said end is removably connected to said strands.

23. The line system according to claim 13, wherein the line system is a boat line system, a rescue line system, an animal leash system, a lasso system, a rappelling line system, a fruit-picking line system, an electrical wiring snake system, or a plumbing snake system.

24. The line system according to claim 13, wherein said pump is a hand pump having:
a bulb;
a connecting tube fluidically connected to said bladder; and
a valve fluidically connecting said bulb to said connecting tube for controlling inflation and deflation of said bladder.

25. The line system according to claim 24, wherein said connecting tube is removably connected to said bladder and to said valve.

26. The line system according to claim 25, further comprising a quick-release connection connecting said connecting tube to said bladder.

27. The line system according to claim 25, further comprising a quick-release connection connecting said valve to said bladder.

28. The line system according to claim 24, wherein said bulb transmits air through said valve when said bulb is compressed to fill said bladder with the air.

29. The line system according to claim 24, wherein said bulb is filled with a fluid and transmits said fluid through said valve when said bulb is compressed to fill said bladder with said fluid.

30. The line system according to claim 24, wherein:
said valve has open and closed settings; and
said valve permits fluidic movement between said pump and said connecting tube in said open setting and prevents fluidic movement between said pump and said connecting tube in said closed setting.

31. The line system according to claim 24, wherein said bulb and said valve are a bulb and valve of a sphygmomanometer.

32. The line system according to claim 13, wherein said pump is a compressed air pump having:
a compressed air container;
a connecting tube fluidically connected to said bladder; and
a valve fluidically connecting said air container to said connecting tube for controlling inflation and deflation of said bladder.

33. The line system according to claim 32, wherein said connecting tube is removably connected to said bladder and to said valve.

34. The line system according to claim 33, further comprising a quick-release connection connecting said connecting tube to said bladder.

35. The line system according to claim 33, further comprising a quick-release connection connecting said valve to said bladder.

36. The line system according to claim 32, wherein said container transmits air through said valve when said air container is opened into said valve.

37. The line system according to claim 32, wherein:
said valve has open and closed settings; and
said valve permits fluidic movement between said air container and said connecting tube in said open setting and prevents fluidic movement between said air container and said connecting tube in said closed setting.

38. The line system according to claim 32, wherein said air container is a CO₂ cartridge.
